(19) United States
(12) Patent Application Publication
(10) Pub. No.: US 2005/0059788 A1
(43) Pub. Date: Mar. 17, 2005

(54) Organic polymer film and method for producing the same

(75) Inventors: Nobutaka Kunimi, Tsukuba-shi (JP); Masashi Komatsu, Nishinomiya-shi (JP); Jun Kawahara, Minato-ku (JP); Yoshihiro Hayashi, Minato-ku (JP)

Correspondence Address: BIRCH STEWART KOLASCH & BIRCH, PO BOX 747, FALLS CHURCH, VA, 22040-0747, US

(73) Assignees: Sumitomo Chemical Company, Limited, Osaka (JP); NEC CORPORATION, Tokyo (JP)

(21) Appl. No.: 10/901,189

(22) Filed: Jul. 29, 2004

(30) Foreign Application Priority Data
Jul. 30, 2003 (JP) P2003-203674

(51) Int. Cl. C08F 38/00

(52) U.S. Cl. 526/285

(57) ABSTRACT

An organic polymer film with high mechanical strength, which is produced by a method comprising the steps of supplying a raw material gas containing an organic compound having at least one carbon-carbon triple bond in a molecule into a reaction chamber under reduced pressure, exciting the raw material gas in plasma generated in the reaction chamber, depositing the excited raw material gas on a surface of a substrate placed in the reaction chamber, and growing an organic polymer film on the surface of the substrate.

### FIELD OF THE INVENTION

The present invention relates to an organic polymer film and a method for producing the same.

### PRIOR ART

Recently, a distance between adjacent wirings of a semiconductor integrated circuit has been very quickly decreased. With the decrease of the distance between wirings, a delay caused by a parasitic capacity between the wirings relatively increases, and the deterioration of a high speed operation performance due to such a delay becomes actual. To cope with this problem, it is required to decrease a capacity between wirings.

To decrease the capacity between wirings, the development of an insulation film with a smaller specific dielectric constant is desired. Among others, the films of organic polymers are promising, since they have a low specific dielectric constant.

For example, JP-A-2000-012532 discloses a method for producing an organic polymer film on the surface of a substrate comprising the steps of vaporizing a divinylsiloxanebisbenzocyclobutene monomer, passing the vaporized monomer through plasma generated in a reaction chamber under a reduced pressure and spraying it on the surface of the substrate to form the organic polymer film. However, the resulting organic polymer film still has room for improving its physical properties such as mechanical strength.

### SUMMARY OF THE INVENTION

An object of the present invention is to provide an organic polymer film having increased mechanical strength.

Another object of the present invention is to provide a method for producing such an organic polymer film.

Accordingly, the present invention provides a method for producing an organic polymer film comprising the steps of:
supplying a raw material gas containing an organic compound having at least one carbon-carbon triple bond in a molecule into a reaction chamber under reduced pressure,
exciting said raw material gas in plasma generated in said reaction chamber,
depositing said excited raw material gas on a surface of a substrate placed in said reaction chamber, and
growing an organic polymer film on the surface of said substrate.

The organic polymer film produced by the above method according to the present invention has high mechanical strength.

### BRIEF DESCRIPTION OF THE DRAWINGS

FIG. 1 schematically shows one example of an apparatus for producing an organic polymer film, which can be used to produce an organic polymer film according to the present invention.

FIG. 2 schematically shows a system for vaporizing a liquid organic compound and supplying the vaporized compound to a reaction chamber together with a carrier gas.

### DETAILED DESCRIPTION OF THE PREFERRED EMBODIMENTS

The method of the present invention uses a gas containing an organic compound having at least one carbon-carbon triple bond as a raw material.

Preferably, the organic compound having at least one carbon-carbon triple bond is a compound of the formula (1) or (2): 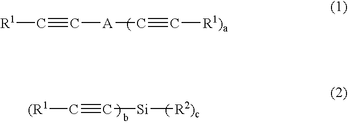
wherein a is an integer of 0 to 3, b is an integer of 1 to 4, c is an integer of 0 to 3 provided that the sum of b and c is 4, A is a mono- to tetravalent organic group, R¹ is a hydrogen atom, a hydrocarbon group having 1 to 6 carbon atoms or a silyl group which may optionally have at least one substituent, and R² is an alkyl group having 1 to 4 carbon atoms, an alkenyl group having 1 to 4 carbon atoms or an alkoxy group having 1 to 4 carbon atom.

Examples of the mono- to tetravalent organic groups for A are aliphatic hydrocarbon groups, alicyclic hydrocarbon groups, aromatic hydrocarbon groups, heterocyclic hydrocarbon groups, fused polycyclic hydrocarbon groups, etc. Among them, aliphatic hydrocarbon groups, alicyclic hydrocarbon groups and aromatic hydrocarbon groups are preferable.

Examples of the aliphatic hydrocarbon groups include saturated or unsaturated, linear or branched hydrocarbon groups having 1 to 12 carbon atoms. The position of the unsaturated bond is not limited, if present.

Examples of the alicyclic hydrocarbon groups include alicyclic hydrocarbon groups having 4 to 12 carbon atoms, which may have one or more unsaturated bonds, and may comprise a bicylo group or a spiro group.

Examples of the aromatic hydrocarbon group include groups having a benzene ring, a naphthalene ring, an anthracene ring, a phenanthrene ring, a fluorene ring, etc.

Examples of the heterocyclic hydrocarbon groups and the fused polycyclic hydrocarbon groups include groups having a nitrogen-containing hetero ring such as pyridine, piperazine, piperidine, pyrazine, imidazole, pyrrolidine, pyrrole, diazine, triazine, pyrimidine, purine; etc.; and groups having an oxygen- or sulfur-containing hetero ring such as furane, morpholine, thiophene, etc.

The aliphatic hydrocarbon groups, alicyclic hydrocarbon groups, aromatic hydrocarbon groups, heterocyclic hydrocarbon groups and fused polycyclic hydrocarbon groups may be substituted with at least one substituent selected from the group consisting of an alkyl group having 1 to 10 carbon atoms, an alkoxy group having 1 to 10 carbon atoms, an acyl group having 2 to 10 carbon atoms, a phenyl group and a phenoxy group.

Specific examples of the alkyl group having 1 to 10 carbon atoms include methyl, ethyl, n-propyl, isopropyl n-butyl, sec-butyl, isobutyl, tert-butyl, pentyl, neopentyl, etc.

Specific examples of the alkoxy group having 1 to 10 carbon atoms include methoxy, ethoxy, n-propoxy, isopropoxy, n-butoxy, sec-butoxy, isobutoxy, tert-butoxy, etc.

Specific examples of the acyl group having 2 to 10 carbon atoms include acetyl, propionyl, butyryl, isobutyryl, benzoyl, etc.

As the substituent, the alkyl group having 1 to 10 carbon atoms is preferable. Among them, methyl, ethyl, n-propyl, isopropyl, n-butyl, isobutyl, sec-butyl and tert-butyl are more preferable.

In the formula (1), suffix a is an integer of 0 to 3, preferably 0 or 1. When suffix a is 0 or 1, A is a mono- or divalent organic group. In such a case, A is preferably an aliphatic hydrocarbon group, an alicyclic hydrocarbon group or an aromatic hydrocarbon group, and more preferably a saturated linear hydrocarbon group having 1 to 6 carbon atoms, a saturated cyclic hydrocarbon group having 5 or 6 carbon atoms, or a group having a benzene ring or a naphthalene ring.

When A is a monovalent organic group, examples of the monovalent group for A include methyl, ethyl, n-propyl, isopropyl, n-butyl, isobutyl, sec-butyl, tert-butyl, vinyl, allyl, ethynyl, propargyl, cyclopentyl, cyclohexyl, cyclobutyl, phenyl, naphthyl, etc.

When A is a divalent organic group, examples of the divalent group for A include methylene, ethylene, propylene, butylene, vinylene, ethynylene, cyclopentylene, cyclohexylene, phenylene, naphthylene, etc.

In the formula (1) or (2), R¹ is a hydrogen atom, a hydrocarbon group having 1 to 6 carbon atoms or a silyl group which may optionally have at least one substituent. When two or more R¹ groups are present in the formula (1) or (2), they may be the same or different.

The hydrocarbon group having 1 to 6 carbon atoms is preferably a saturated hydrocarbon group having 1 to 6 carbon atoms, more preferably, an alkyl group having 1 to 6 carbon atoms, in particular, an alkyl group having 1 to 4 carbon atoms.

Specific examples of the alkyl group having 1 to 6 carbon atoms include methyl, ethyl, n-propyl, isopropyl, n-butyl, isobutyl, sec-butyl, tert-butyl, pentyl, neopentyl, etc.

The silyl group which may optionally have at least one substituent is preferably a silyl group substituted with one or more saturated or unsaturated hydrocarbon groups. Specific examples of such a silyl group include trimethylsilyl, dimethylethylsilly, methyldiethylsilyl, triethylsilyl, dimethylvinylsilyl, methyldivinylsilyl, trivinylsilyl, triallylsilyl, etc.

R¹ is preferably a hydrogen atom, an alkyl group having 1 to 4 carbon atoms (e.g. methyl, ethyl, n-propyl, isopropyl, n-butyl, isobutyl, sec-butyl, tert-butyl, etc.), trimethylsilyl and trivinylsilyl. In particular, a hydrogen atom, an alkyl group having 1 to 4 carbon atoms (e.g. methyl, ethyl, n-propyl, n-butyl, tert-butyl, etc.) and trimethylsilyl are preferable.

Preferable examples of the compound of the formula (1) include 1-propyne, 1-butyne, 3-methyl-1-butyne, 3,3-dimethyl-1-butyne, 1-pentyne, 3-methyl-1-pentyne, 4-methyl-1-pentyne, 3,3-dimethyl-1-pentyne, 3,4-dimethyl-1-pentyne, 4,4-dimethyl-1-pentyne, 1-hexyne, 1-but-3-yne, 1,3-butadiyne, 1-pent-4-yn, cyclopentylacetylene, cyclohexylacetylene, phenylacetylene, (methylphenyl)acetylene, (ethylphenyl)acetylene, (propylphenyl)acetylene, (butylphenyl)acetylene, trimethylsilylethynylbenzene, 1,4-pentadiyne, 3-methyl-1,4-pentadiyne, 3,3-dimethyl-1,4-pentadiyne, 1,5-hexadiyne, 3-methyl-1,5-hexadiyne, 3,3-dimethyl-1,5-hexadiyne, 3,4-dimethyl-1,5-hexadiyne, 4,4-dimethyl-1,5-hexadiyne, 1,3-diethynylcyclopentane, 1,3-diethynylcyclohexane, 1,4-diethynylcyclohexane, 1,2-diethynylbenzene, 1,3-diethynylbenzene, 1,4-diethynylbenzene, methyldiethynylbenzene, ethyldiethynylbenzene, propyldiethynylbenzene, butyldiethynylbenzene, 1,2-di(tert-butylethynyl)benzene, 1,3-di(tert-butylethynyl)benzene, 1,4-di(tert-butylethynyl)benzene, 1,2-di(trimethylsilylethynyl)benzene, 1,3-di(trimethylsilylethynyl)benzene, 1,4-di(trimethylsilylethynyl)benzene, etc.

In the formula (2), R² is an alkyl group having 1 to 4 carbon atoms, an alkenyl group having 1 to 4 carbon atoms or an alkoxy group having 1 to 4 carbon atom. When two or more R² group are present in the formula (2), they may be the same or different.

Specific examples of the alkyl group having 1 to 4 carbon atoms include methyl, ethyl, n-propyl, isopropyl n-butyl, isobutyl, sec-butyl, tert-butyl, etc.

Specific examples of the alkenyl group having 1 to 4 carbon atoms include vinyl, allyl, etc.

Specific examples of the alkoxy group having 1 to 4 carbon atoms include methoxy, ethoxy, etc.

In the formula (2), suffix b is an integer of 1 to 4, and suffix c is an integer of 0 to 3, provided that the sum of b and c (b+c) is 4. Preferably, suffix b is 1 or 2.

Preferable examples of the compound of the formula (2) include trimethylsilylacetylene, bis(trimethylsilyl)acetylene, triethylsilylacetylene, bis(triethylsilyl)acetylene, diethynyldimethylsilane, diethynyldiethylsilane, diethynyldimethoxysilane, diethynyldiethoxysilane, etc.

The raw material gas may contain a gas prepared by vaporizing the organic compound having at least one carbon-carbon triple bond in a molecule or a mixture containing the organic compound having at least one carbon-carbon triple bond in a molecule, and a gas prepared by vaporizing an organic compound copolymerizable with the organic compound having at least one carbon-carbon triple bond in a molecule.

Examples of the organic compound copolymerizable with the organic compound having at least one carbon-carbon triple bond in a molecule include an organic compound having at least one carbon-carbon double bond in a molecule, etc.

Preferably, the organic compound having at least one carbon-carbon double bond in a molecule is a compound of the formula (3): 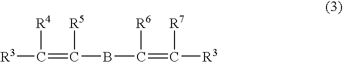
wherein B is a single bond or a divalent bonding group, R³ is a hydrogen atom or a phenyl group which may optionally have at least one substituent, and R⁴ to R⁷ represent independently each other a hydrogen atom or an aliphatic hydrocarbon group.

Examples of the divalent bonding group include an alkylene group, a cycloalkylene group, a divalent group having an aromatic ring, and a group of the formula (4): 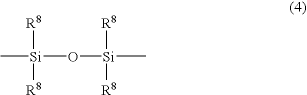
wherein R⁸ is a hydrogen atom or a methyl group.

The alkylene group, the cycloalkylene group or the divalent group having an aromatic ring may be substituted with at least one substituent selected from the group consisting of an alkyl group having 1 to 10 carbon atom, an alkoxy group having 1 to 10 carbon atoms, an acyl group having 2 to 10 carbon atoms, a phenyl group and a phenoxy group.

Examples of the alkyl group having 1 to 10 carbon atom, the alkoxy group having 1 to 10 carbon atoms and the acyl group having 1 to 10 carbon atoms are the same as the groups exemplified in the above.

The substituent is preferably the alkyl group having 1 to 10 carbon atoms, more preferably, methyl, ethyl, n-propyl, isopropyl, n-butyl, isobutyl, sec-butyl, tert-butyl, etc.

B is preferably a single bond, an alkylene group having 1 to 6 carbon atoms, a cycloalkylene group having 3 to 6 carbon atoms, a phenylene group or a group of the formula (4), more preferably a single bond, methylene, ethylene, propylene, butylene, phenylene or a group of the formula (4) in which R⁸ is methyl, in particular, a single bond, phenylene or a group of the formula (4) in which R⁸ is methyl.

R³ is a hydrogen atom or a phenyl group which may optionally have at least one substituent. Examples of the phenyl group which may optionally have at least one substituent include a group of the formula (5) or (6):

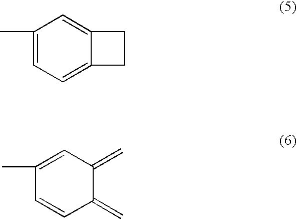

Among them, the group of the formula (6) is more preferable.

R⁴ to R⁷ represent independently each other a hydrogen atom or an aliphatic hydrocarbon group.

Examples of the aliphatic hydrocarbon groups include saturated or unsaturated, linear or branched hydrocarbon groups having 1 to 6 carbon atoms. The position of the unsaturated bond is not limited, if present.

Specific examples of the saturated or unsaturated hydrocarbon group having 1 to 6 carbon atoms include methyl, ethyl, n-propyl, isopropyl, n-butyl, isobutyl, sec-butyl, tert-butyl, vinyl, allyl, ethynyl, propargyl, etc.

R⁴ to R⁷ are preferably hydrogen atoms.

Examples of the compound of the formula (3) include 1,3-butadiene, 1,3-divinylbenezene, 1,4-divinylbenzene, methyldivinylbenzene, ethyldivinylbenzene, propyldivinylbenzene, butyldivinylbenzene, a compound of the formula (7) or (8):

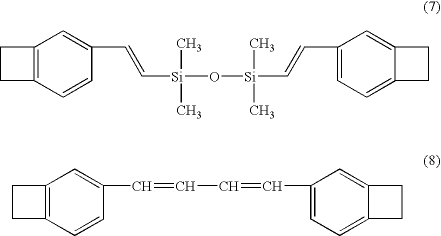

Among them, a compound of the formula (7) is preferable.

When the organic polymer film is produced in the plasma using the raw material gas containing the organic compound having at least one carbon-carbon triple bond in a molecule, the inside of the resulting polymer film has a greatly different chemical structure from that of a polymer film produced from a conventional raw material. Therefore, the method of the present invention can produce the organic polymer film having a very low specific dielectric constant and high mechanical property, which cannot be produced heretofore.

When the organic polymer film is produced using the raw material gas containing the organic compound having at least one carbon-carbon triple bond in a molecule, the carbon-carbon triple bonds themselves are reacted and crosslinked each other to form an aromatic backbone, which is known as a stiffer chemical structure than the crosslinked structure of a cyclohexene backbone prepared using divinylsiloxanebisbenzocyclobutene. Thus, the organic polymer film having excellent mechanical strength and heat resistance can be obtained. Furthermore, a three-dimensional network structure including micropores of a molecular size inside the polymer can be formed by the crosslinking of the carbon-carbon triple bonds by themselves. The formation of the micropores contributes to the decrease of the specific dielectric constant. Since the three-dimensional network structure is known as a backbone with good heat resistance, it is possible to produce the organic polymer having good heat resistance in addition to a low specific dielectric constant.

When two or more raw materials are used to produce an organic polymer film, a gas containing the organic compound having at least one carbon-carbon triple bond in a molecule and a gas containing an organic compound copolymerizable with the organic compound having at least one carbon-carbon triple bond in a molecule are preferably used as the raw materials. In this case, the resulting organic polymer film comprises the copolymer of the two or more raw materials.

For example, when the organic compound having at least one carbon-carbon triple bond in a molecule and divinylsiloxanebisbenzocyclobutene are used as two raw materials, the carbon-carbon triple bond and the benzocyclobutene ring react to form a 1,4-dihydronaphthalene backbone, which is easily dehydrogenated to form a thermally stable naphthalene ring. The naphthalene backbone is known as a stiff structure, and thus, the organic polymer film of the present invention has high mechanical strength.

When the organic polymer film is produced in the plasma using the organic compound having at least one carbon-carbon triple bond in a molecule, it has the specific structure, which cannot be formed from the conventionally used raw material or raw materials only by changing the film-forming conditions such as plasma conditions, a substrate temperature, and the like. Accordingly, the present invention can improve the mechanical strength and heat resistance of the organic polymer film and decrease the specific dielectric constant of the film.

When the organic polymer film is produced using the organic compound having at least one carbon-carbon triple bond in a molecule (organic compound A) and the organic compound copolymerizable with organic compound A (organic compound B), one compound is copolymerized with the other to form a copolymer, while each organic compound is homopolymerized. Thus, a ratio of organic compound A and organic compound B is greatly changed so that local structures originated from the homopolymerization reaction of organic compound A or organic compound B are introduced in the film structure besides the copolymer structure comprising organic compounds A and B. Thereby, a copolymer film having a composition which reflects the supply ratio of organic compound A and organic compound B can be prepared.

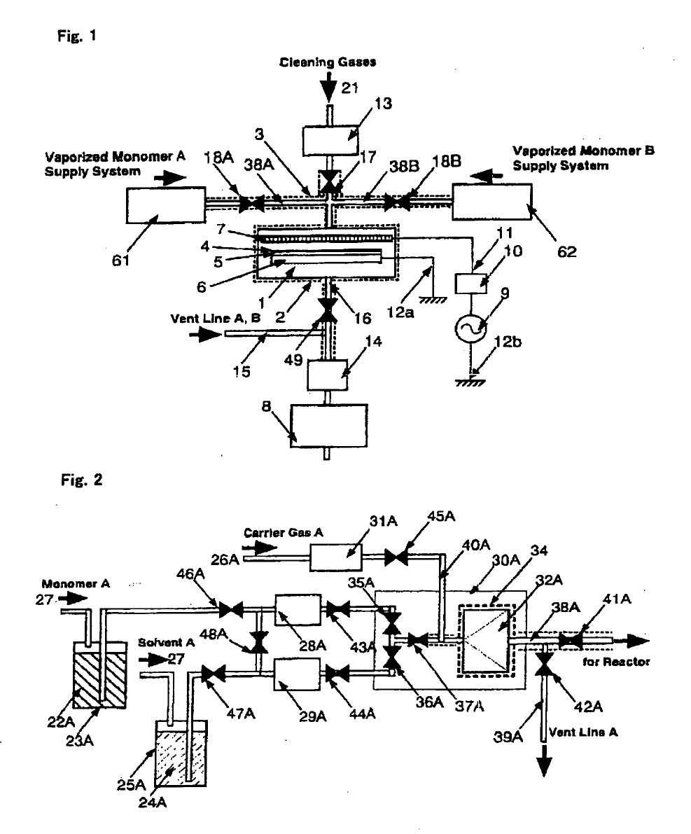

Now, one example of an apparatus for producing an organic polymer film according to the present invention is explained by making reference to FIG. 1, which schematically shows such an apparatus. Hereinafter, a method for producing an organic polymer film using the above two raw materials is explained. However, an organic polymer film can be produced from a single raw material or three or more raw materials by an analogous method thereto.

In FIG. 1, a reaction chamber 1 is depressurized with a vacuum pump 8, and a substrate-heating member 6 is provided inside the reaction chamber 1. As a base material on which a copolymer film is formed, a semiconductor substrate 5 is fixed to the upper surface of the substrate-heating member 6. Organic compound A and organic compound B as raw materials are vaporized in vaporizing supplying systems 61, 62, respectively, and the vapors of organic compounds A and B are supplied to the reaction chamber 1 together with carrier gasses via vaporized compound-supply pipes 38A, 38B and valves 18A, 18B, respectively. Before reaching the reaction chamber 1, the pipe walls of the pipes 38A, 38B are heated with a heater 3 so that the pipe wall temperatures are maintained at such a temperature that the partial pressures of organic compounds A and B are always lower than the respective equilibrium vapor pressures thereof at the pipe wall temperature. The vapors of organic compounds A and B, which are transported with the carrier gas, are supplied to a shower head 7 in the reaction chamber 1 and mixed, and the vapor mixture is sprayed on the surface of the substrate 5. Between the shower head 7 and the substrate-heating member 6, a RF power is applied from a RF power source 9 to induce plasma. Accordingly, the molecules of organic compounds A and B are excited while they are passing through the plasma generated and then reach the surface of the substrate in the activated state. Then, the molecules are deposited on the surface of the substrate 5 which is heated with the substrate-heating member 6, and the thermal energy is imparted to the already activated molecules of organic compounds A and B so that they are quickly copolymerized. Consequently, an insulation film 4 of the copolymer comprising organic compounds A and B grows on the surface of the semiconductor substrate 5.

In general, when a film is formed by depositing a gas on a substrate, the process of the formation of the film through a reaction and the process of the desorption of the gas from the substrate are competitive. When plural raw materials are used, the rates of desorption of the raw materials are different. Therefore, the ratio of the raw materials in the copolymer film should be controlled by taking the rates of desorption of the raw materials into account.

In contrast, when the gas containing organic compounds A and B is excited with plasma and deposited on the substrate, the excited molecules of organic compounds A and B can be quickly copolymerized after they are deposited on the surface of the substrate. Thus, the desorption of the molecules of organic compounds A and B has minimal influence on the composition of the copolymer. Thus, it is not necessary to take the rates of desorption of organic compounds A and B into account in the method of the present invention. Consequently, the ratio of organic compounds A and B in the copolymer can be easily controlled.

In some cases, during the activation with plasma, a part of the activated raw material compounds may be oligomerized in a gas phase to form dimers, trimers, etc., which are deposited on the surface of the substrate. In such cases, since raw material compounds A and B are mixed in an atmosphere under reduced pressure in which the molecules of the compounds have large mobility, the dimers, trimers or oligomers have a composition corresponding to the mixing ratio of organic compounds A and B in the raw material gas. Accordingly, the insulation film of a copolymer which uniformly comprises the units derived from organic compounds A and B can be obtained. When plural raw material compounds having different equilibrium vapor pressures (saturation vapor pressures) with different orders of magnitude, the influence of the difference of the rate of desorption may increase. However, when dimers, trimers or oligomers are formed by intentionally oligomerizing a part of the raw material compounds in the plasma, they have much smaller equilibrium vapor pressure than the monomers, so that the influence of the desorption can be avoided. For example, in a case where the equilibrium vapor pressures of the raw materials are different by about three figures, when the above method is used, the difference of the rates of desorption is substantially negligible. In such a case, the distribution of the composition in the insulation film of the copolymer causes no practical problem.

The raw materials are sprayed in the form of a mixed gas on the surface of the substrate. It is necessary for the mixing ratio of the raw materials contained in the mixed gas to be made substantially the same anywhere on the surface of the substrate. The raw materials may be uniformly mixed in the reaction chamber by, for example, mixing them with the shower head 7 placed in the reaction chamber. Alternatively, the raw materials may be uniformly mixed in a passageway before they are introduced in the reaction chamber, and then introduced in the reaction chamber. To uniformly mix the raw materials in the passageway, the flows of the raw materials are combined in a pipe, or a mixing chamber is placed in the apparatus and the raw materials are mixed in the mixing chamber while the materials are retained therein.

The unreacted raw materials do not deposit or condense on the walls of the reaction chamber 1 since the reaction chamber 1 is depressurized with the vacuum pump 8 and the wall of the reaction chamber 1 is heated like the vaporized compound-supply pipes 38A, 38B. Therefore, the unreacted raw materials in a gas state reach a cold trap 14 via a discharging pipe 16 which is heated with a heater. In the cold trap 14, both raw materials A and B in the gas state condense to liquefy or solidify since the temperature on the inside surface of the cold trap is sufficiently low. As a result, the unreacted raw materials are recovered and removed in the cold trap 14, while the carrier gas, from which the raw materials have been removed, is transported to the vacuum pump 8.

FIG. 2 schematically shows a system for vaporizing a liquid organic compound and supplying the vaporized compound to the reaction chamber together with a carrier gas, when an organic compound used in the method of the present invention is liquid at room temperature. FIG. 2 shows the flow of the organic compound A from its vaporization in a vaporization controller to just before the supply to the reaction chamber.

An organic compound 22A is supplied to a vaporization controller 30A via a valve 46A, a liquid flow meter 28A and a valve 43A. Then, organic compound 22A is supplied to a vaporizing chamber 32A via a vaporization control valve 35A and a valve 37A in the controller, both of which are controlled with feedback signals from the liquid flow meter 28A for the organic compound 22A. Separately, a carrier gas 26A is supplied to the controller 30A via a valve 45A. Then, the carrier gas 26A and the organic compound 22A are mixed just upstream the vaporizing chamber 32A. The organic compound 22A, which is mixed with the carrier gas 26A and supplied to the vaporizing chamber 32A, is continuously vaporized since it is heated with a thermal energy generated with a heater 34 and also the vaporizing chamber 32A is depressurized. That is, the cooling of the organic compound 22A, which is caused by a thermal energy consumed as a heat of evaporation and the volume expansion of the carrier gas due to the sudden drop of the pressure, is compensated with a thermal energy supplied by heating with the heater 34. Therefore, the organic compound 22A is heated to a sufficiently high temperature and then supplied to the reaction chamber 1 via the vaporized compound-supply pipe 38A and the valve 18A which are heated with the heater 34.

When the organic compounds used in the method of the present invention are solids, a suitable vaporizing-supplying system may be selected as in the case of the liquid organic compounds.

As explained above, the organic compounds, which may be liquid or solid at room temperature, can be supplied in the gas state to the reaction chamber with quickly changing a supply rate to a desired rate by choosing a suitable vaporizing supplying system. If the organic compounds, which are in the gas state at room temperature, can be used, they may be supplied in the same manner as in the case of supplying conventional raw material gases.

The carrier gas used in the method of the present invention may be any gas inert to the organic compounds, for example, helium gas, argon gas, neon gas, nitrogen gas, etc.

To control the production of the organic polymer film, other hydrocarbon gas such as methane, ethane, propane, butane, ethylene, propane, acetylene, allene, etc. may be added to the raw material compounds.

The organic polymer film produced by the method of the present invention has a low specific dielectric constant and high mechanical strength, and thus it can preferably be used as an insulation film with a low dielectric constant, which insulates multilayer wirings of a semiconductor integrated circuit.

### EXAMPLES

The present invention will be illustrated by the following examples, which do not limit the scope of the present invention in any way.

### Example 1

This Example explains a method for producing an organic polymer film using 1,3-diethynylbenzene as organic compound A by vaporizing this compound with a vaporizing-supplying system 61 for monomer A shown in FIG. 1.

In the initial state of the vaporization controller of the apparatus for forming a polymer film (FIGS. 1 and 2), the valves 37A, 41A and 49 are “opened”, while the valve 18B is “closed”, and the reaction chamber 1, discharge pipe 16, effluent pipe 15, vaporizing chamber 32A and vaporized compound-supply pipe 38A are evacuated with the vacuum pump 8.

An vaporizing temperature is preferably a high temperature sufficient for attaining a required supply amount of organic compound A, but should not be so high as to cause the denaturation such as decomposition or polymerization of organic compound A, and the clogging of the pipes due to such denaturation in the pipes through which organic compound A to be vaporized is transported to the vaporizing chamber. The pipes such as the vaporized compound-supply pipe 38A and the like, which are heated with the heater 3, should be made of materials which can withstand such a heating temperature, or the heating temperature is selected so that the pipe materials can withstand such a temperature. The temperatures of the pipes being heated are monitored with thermocouples attached to various positions of the pipes, and the outputs of the heaters for heating the pipes are controlled so that the temperatures of the pipes are maintained in preset temperature ranges. Then, the valve 45A of the vaporizing-supplying system shown in FIG. 2 is “opened”, and the carrier gas 26A (helium gas) is supplied to the vaporization controller 30A via a carrier gas-supplying pipe 40A using a gas flow-controller 31A, and further flowed to the reaction chamber 1 via the vaporized compound-supply pipe 38A. Finally, the mixture of the unreacted compound A and the carrier gas is discharged outside the reaction chamber with the vacuum pump 8 via the discharge pipe 16. In this step, the vaporizing temperature is set to 80° C. The flow rate of the helium carrier gas is adjusted at 500 sccm. Under such conditions, the total pressure P in the vaporization controller is 7 Torr, and the internal pressure of the reaction chamber 1 is 2.0 Torr. The silicon substrate 5 (semiconductor substrate) on which an integrated circuit is printed is heated at 400° C. with the substrate heater 6 placed in the reaction chamber 1. The substrate temperature during the formation of a polymer film is preferably in the range from 200° C. to 450° C.

With the organic monomer-vaporizing supplying system 61 shown in FIG. 2, the vaporized organic compound A is supplied together with the carrier gas to the reaction chamber 1 via the vaporized compound-supply pipe 38A. The mixed gas containing organic compound A is distributed with the shower head 7 in the reaction chamber 1 and sprayed on the surface of the substrate 5.

To the shower head 7, a RF powder of 13.56 MHz is applied in relation to the surface of the substrate heater 6 which is grounded. Thereby, the plasma of helium used as the carrier gas is generated below the shower head 7. In this case, the RF powder should have a plasma energy in a level sufficient for only activating organic compound A. The vaporized organic compound A is activated while it is sprayed on the substrate 5 through the helium plasma. The preactivated organic compound A is polymerized on the surface of the substrate 5 which is heated at 400° C. Thereby, a polymer film (organic insulation film) is produced on the substrate. In this process, the carrier gas containing the unreacted organic compound A reaches the discharge pipe 16, and the unreacted organic compound A is reliquefied (condensed) with the cold trap 14 which is cooled around 20° C. Thus, the unreacted organic compound A does not get in the vacuum pump 8. Organic compound A is supplied and the formation of the film is continued until the total amount of organic compound A reaches a predefined amount. Then, the supply of organic compound A is stopped, and the semiconductor substrate 5 is removed from the reaction chamber.

The polymerization of 1,3-diethynylbenzene may proceed through the crosslinking of the two ethynyl groups in the molecule. The crosslinking reaction includes the formation of a benzene ring by trimerization, the formation of a linear polyene backbone, the formation of diacetylene known as the Glaser Coupling, the formation of the ene-yne backbone known as the Straus Coupling, the Diels-Alder reaction of the ethynyl group with diene, diacetylene or the ene-yne backbone and subsequent transfer reaction, and an aromatization reaction. Such crosslinking and aromatization reactions proceed smoothly, and a three-dimensional network structure having uniform micropores with molecular sizes is formed, when the organic compounds are passed through the plasma just before spraying and activated by the plasma energy. The polymer having micropores therein has a smaller specific dielectric constant than a polymer having no micropore. For example, the specific dielectric constant of the polymer having the micropores is about 2.0 to about 2.2.

### Example 2

A film of a copolymer comprising raw material A and raw material B (an organic insulation film) is produced in the same manner as in Example 1 except that 1,3-diethynylbenzene is used as raw material A, the compound having the formula (5) is used as raw material B. Here, raw material B is divinylsiloxane-benzocyclobutene of the formula (7). Raw materials A and B are vaporized with the organic monomer A-vaporizing supplying system 61 and the organic monomer B-vaporizing supplying system 62 respectively and then mixed together with helium carrier gas and supplied to the reaction chamber 1 via the vaporized compound-supply pipes 38A, 38B.

The copolymerization of 1,3-diethynylbenzene and the compound having the formula (5) proceeds such that the benzocyclobutene structure of the formula (5) is ring-opened to form the 1,2-divinylidene structure of the formula (6), and then the 1,2-divinylidene structure reacts with the ethynyl groups of 1,3-diethynylbenzene by the Diels-Alder reaction to form the 1,4-dihydronaphthalene structure. Thereby, 1,3-diethynylbenzene and the compound having the formula (5), or essentially the formula (7), can form the three-dimensional crosslinked structure. Furthermore, since the mixture of the vaporized monomers is passed through the plasma just before being sprayed over the substrate and thus the monomers are activated with the plasma energy and then reacted, the thermally stable naphthalene ring structure can be formed. Accordingly, the produced organic polymer film has good mechanical properties.

1. A method for producing an organic polymer film comprising the steps of:
supplying a raw material gas containing an organic compound having at least one carbon-carbon triple bond in a molecule into a reaction chamber under reduced pressure,
exciting said raw material gas in plasma generated in said reaction chamber,
depositing said excited raw material gas on a surface of a substrate placed in said reaction chamber, and
growing an organic polymer film on the surface of said substrate.

2. The method according to claim 1, wherein said organic compound having at least one carbon-carbon triple bond in a molecule is at least one compound selected from the group consisting of a compound of the formula (1): 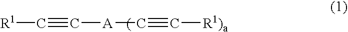
and a compound of the formula (2): 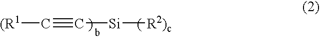
wherein a is an integer of 0 to 3, b is an integer of 1 to 4, c is an integer of 0 to 3 provided that the sum of b and c is 4, A is a mono- to tetravalent organic group, R¹ is a hydrogen atom, a hydrocarbon group having 1 to 6 carbon atoms or a silyl group which may optionally have at least one substituent, and R² is an alkyl group having 1 to 4 carbon atoms, an alkenyl group having 1 to 4 carbon atoms or an alkoxy group having 1 to 4 carbon atom.

3. The method according to claim 2, wherein A in the formula (1) is an aliphatic hydrocarbon group, an alicyclic hydrocarbon group, an aromatic hydrocarbon group, a heterocyclic group or a fused polycyclic hydrocarbon group.

4. The method according to claim 2, wherein A in the formula (1) is an aliphatic hydrocarbon group, an alicyclic hydrocarbon group or an aromatic hydrocarbon group.

5. The method according to claim 2, wherein R¹ is a hydrogen atom, an alkyl group having 1 to 4 carbon atom or a trimethylsilyl group, and R² is a methyl group.

6. The method according to claim 2, wherein a in the formula (1) is 0 or 1, and b in the formula (2) is 1 or 2.

7. The method according to claim 1, wherein said raw material gas contains a gas prepared by vaporizing said organic compound having at least one carbon-carbon triple bond in a molecule or a mixture containing said organic compound having at least one carbon-carbon triple bond in a molecule, and a gas prepared by vaporizing an organic compound compolymerizable with said organic compound having at least one carbon-carbon triple bond in a molecule.

8. The method according to claim 1, wherein said organic compound compolymerizable with said organic compound having at least one carbon-carbon triple bond in a molecule is an organic compound having at least one carbon-carbon double bond in a molecule.

9. The method according to claim 1, wherein said organic compound having at least one carbon-carbon double bond in a molecule is a compound of the formula (3): 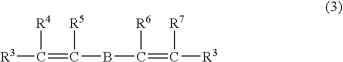
wherein B is a single bond or a divalent bonding group, R³ is a hydrogen atom or a phenyl group which may optionally have at least one substituent, and R⁴ to R⁷ represent independently each other a hydrogen atom or an aliphatic hydrocarbon group.

10. The method according to claim 9, wherein said compound of the formula (3) is a compound of the formula (7):

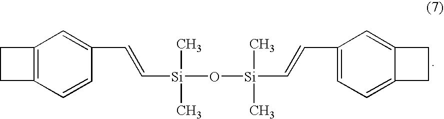

11. The method according to claim 1, wherein said substrate is a semiconductor substrate.

12. An organic polymer film obtainable by a method of any one of claims 1 to 11.
